(19) United States
(12) Patent Application Publication
(10) Pub. No.: US 2003/0146817 A1
(43) Pub. Date: Aug. 7, 2003

(54) ELECTRICAL FILTER

(76) Inventor: Mei-Yu Lo, Taoyuan Hsien (TW)

Correspondence Address: VENABLE BAETJER HOWARD AND CIVILETTI, 1201 NEW YORK AVE. NW SUITE 1000, WASHINGTON, DC, 20005, US

(21) Appl. No.: 10/066,646

(22) Filed: Feb. 6, 2002

(51) Int. Cl. H01F 27/24

(52) U.S. Cl. 336/212

(57) ABSTRACT

A filter is composed of a magnetic core, and at least three coils. The magnetic core has an upper plate, a lower plate parallel to the upper plate and two walls formed between the upper plate and the lower plate. The first coil and the second coil are respectively winded on the walls. The other coil is winded on the upper plate. Terminals of the coils are bonded on a bottom surface of the lower plate.

### BACKGROUND OF THE INVENTION

1. Field of the Invention

The present invention is related to an electrical filter, and more particularly to a filter which has at least three coils winded therein.

2. Description of Related Art

As an anti-EMI (Electro Magnetic Interference) device, electrical filters are generally connected in an IC (Integrated Circuit) to remove noises in signals. Referring to FIG. 7, an IC (70) has a plurality of electrical filters (80) provided at an input end. A plurality of capacitors (81) and another plurality of electrical filters (80) are electrically connected at an output end of the IC (70) for amplifying input signals. The filters (80) are assembled on a circuit board by means of SMT (Surface Mounting Technology).

However, the conventional filters each have only two coils formed therein. When a requirement of the filter increases, the operation time is also extended. Moreover, a great quantity of filters will occupy a large space on the circuit board, thereby increasing the volume of the circuit board.

Therefore, the invention provides an improved filter to mitigate and/or obviate the aforementioned problems.

### SUMMARY OF THE INVENTION

The main objective of the invention is to provide an electrical filter which has at least three coils.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical filter in accordance with the invention.

FIG. 2 is a side view of the electrical filter;

FIG. 3 is a perspective view of a magnetic core of the electrical filter;

FIG. 4 is a side view of the magnetic core;

FIG. 5 is a side view of a magnetic core of a second embodiment of the invention;

FIG. 6 is a side view of a magnetic core of a third embodiment of the invention; and

FIG. 7 is a diagram of a circuit including conventional filters.

### DETAILED DESCRIPTION OF THE PREFERRED EMBODIMENT

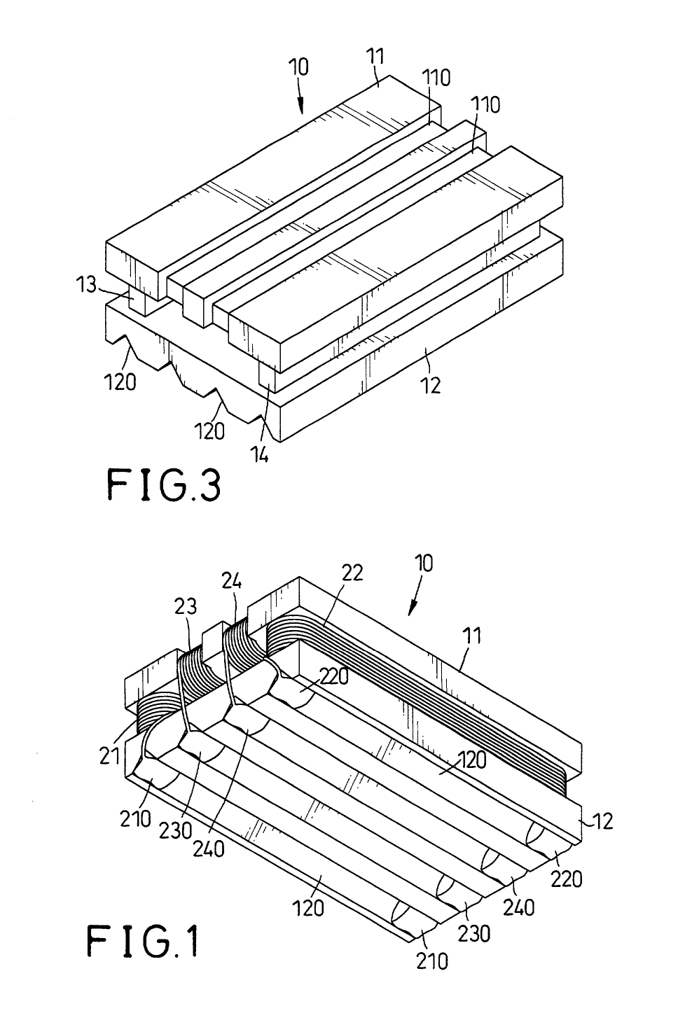

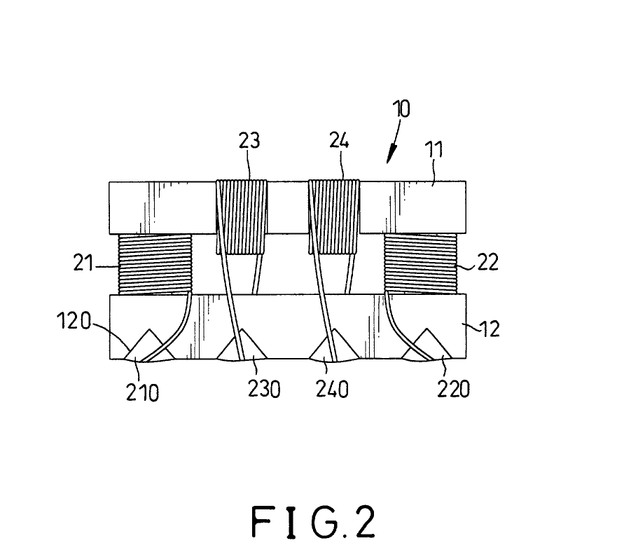

Referring to FIGS. 1-4, an electrical filter in accordance with the invention is composed of a magnetic core (10) and a plurality of coils winded on the magnetic core (10). According to the invention, the quantities of the coils are at least three. In a first embodiment of the invention illustrated in FIGS. 1-3, the filter has four coils (21, 22, 23, 24) winded on the magnetic core (10).

The magnetic core (10), of which a cross section is like a “II”, has an upper plate (11), a lower plate (12) parallel to the upper plate (10), and two walls (13, 14) formed between the upper plate (11) and the lower plate (12). A first coil (21) and a second coil (22) are respectively winded on the first wall (13) and the second wall (14). Two parallel first channels (110) are defined on the upper plate (11), and the third and the fourth coils (23, 24) are winded in the channels (110).

The lower plate (12) has four parallel second channels (120) defined on a bottom surface thereof. Terminals (210, 220, 230, 240) of the coils (21, 22, 23, 24) are respectively bonded at ends of the second channels (120) and slightly protruded from the bottom surface of the lower plate (12). When the filter is used, the terminals (210, 220, 230, 240) are electrically contacted with the circuit.

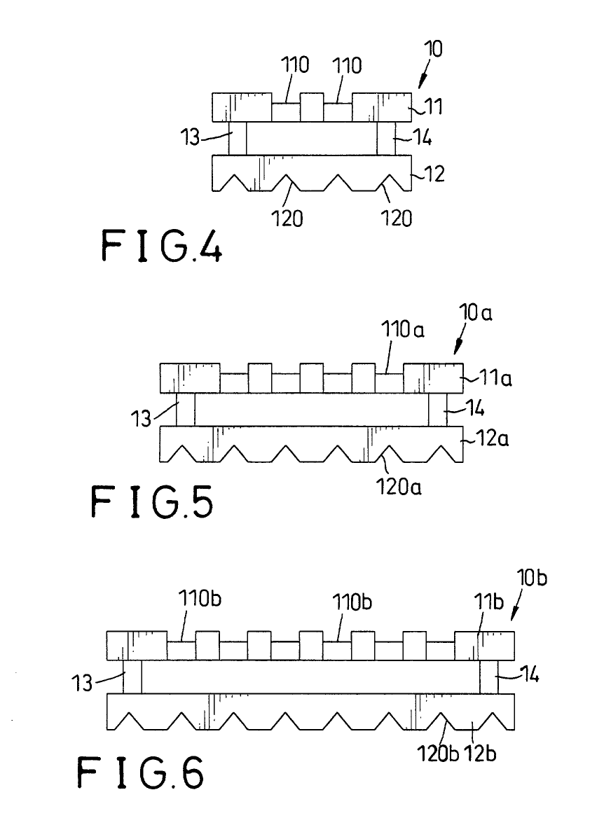

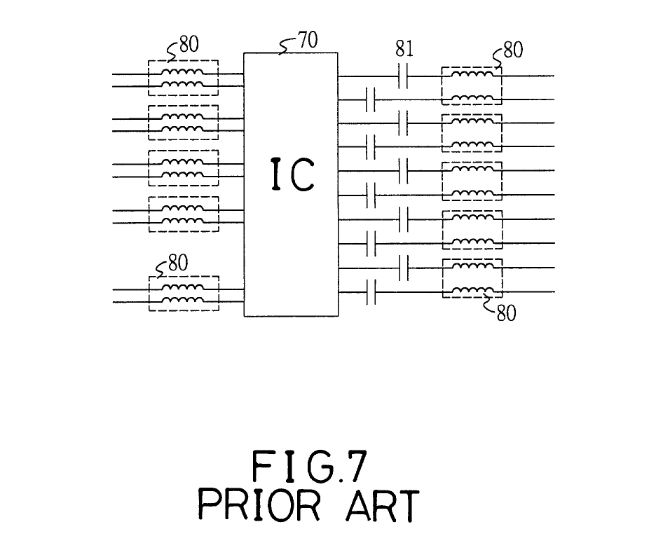

Referring to FIG. 5, in a second embodiment of the invention, the magnetic core (10a) has four first channels (110a) defined on the upper plate (11a) and each first channel (110a) respectively having third, fourth, fifth and sixth coils winded therein, and six second channels (120a) defined at the bottom surface of the lower plate (12a). Thus, the filter has six coils winded thereon. In a third embodiment shown in FIG. 6, the magnetic core (10b) has six first channels (110b) defined on the upper plate (11b) and each first channel (110b) respectively having third, fourth, fifth, sixth, seventh and eighth coils winded therein, and eight second channels (120b) defined at the bottom surface of the lower plate (12b).

Because the filter has more coils assembled therein, total quantities of the filters used in a circuit can be reduced and the operation time is also shortened. Consequently, an electric product including the filters has a low cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A filter comprising:
a magnetic core (10), the magnetic core (10) having an upper plate (11), a lower plate (12) parallel to the upper plate (11), and two walls (13, 14) formed between the upper plate (11) and the lower plate (12); and
a first coil (21), a second coil (22) and at least a third coil (23), wherein the first coil (21) and the second coil (22) are respectively winded on the walls (13, 14), and the at least a third coil (23) is winded on the upper plate (11), terminals (210, 220, 230) of the coils (21, 22, 23) are bonded on a bottom surface of the lower plate (12).

2. The filter as claimed in claim 1, wherein the upper plate (11) has at least one first channel (110) defined thereon, and the at least a third coil (23) on the upper plate (11) is winded in the first channel (110).

3. The filter as claimed in claim 1, wherein the lower plate (12) has at least three second channels (120) defined at the bottom surface thereof, and the terminals (210, 220, 230) are bonded in the three second channels (120) respectively.
